(19) United States
(12) Patent Application Publication
(10) Pub. No.: US 2021/0199390 A1
(43) Pub. Date: Jul. 1, 2021

(54) Method and Adjustment System for Controlling the Recovery of Heat Energy from Wastewater Flowing in a Spiral Pipe Present Inside a Container

(71) Applicant: Ecopal Oy, Lahti (FI)

(72) Inventors: Jouni HELPPOLAINEN, Lahti (FI); Aarni TERVONEN, Kokkoia (FI)

(73) Assignee: Ecopal Oy, Lahti (FI)

(21) Appl. No.: 16/761,828

(22) PCT Filed: Nov. 6, 2018
(86) PCT No.: PCT/FI2018/050811

§ 371 Date: May 6, 2020

(30) Foreign Application Priority Data
Nov. 6, 2017 (FI) 20175984

(51) Int. Cl. F28D 21/00; F28D 7/02

(52) U.S. Cl. CPC F28D 21/0012; F28D 7/022

(57) ABSTRACT

The invention relates to a method for controlling the recovery of heat energy from a wastewater (J) flow present in a spiral pipe (2) into a heat transfer fluid (L) flowing in a first heat transfer space (4) inside a container (1) with a temperature difference between the wastewater (J) and the heat transfer fluid (L). The method comprises the steps of adjusting the ratio (V3N5) of two heat transfer fluid volume flows (V3, V5) by adjusting the heat transfer coefficient through the spiral pipe's (2) walls by means of form factors of the spiral pipe's helices (21-28), by measuring the temperature of the heat transfer fluid (L) and/or the temperature of the wastewater (J), and by controlling the temperature of the wastewater (J) to be all the time higher than the temperature of the heat transfer fluid (L). The invention also relates to an adjustment system.

The invention relates to a method according to the preamble of claim 1 for controlling the recovery of heat energy from wastewater flowing in a spiral pipe present inside a container.

The invention relates also to an adjustment system for controlling the recovery of heat energy from wastewater flowing in a spiral pipe present inside a container.

In view of recovering the heat energy of municipal wastewaters, and particularly residential wastewaters, there are prior known recovery systems, wherein the recovery system comprises a shell and tube heat exchanger made up of a tube side (primary side) and a shell side (secondary side) surrounding the same, said shell side being used for conveying a heat transfer fluid. In some shell and tube heat exchanger models, the shell and tube heat exchanger's tube side is given a spiral configuration for ensuring a good heat transfer area and thereby heat transfer co-efficient. However, these wastewater energy recovery systems involve several problems.

One problem found generally in heat transfer assemblies equipped with a shell and tube heat exchanger and designed for recovering the energy of municipal wastewaters and residential wastewaters is that the flow of wastewater into the recovery system and thereby also into the shell and tube heat exchanger's primary side may occur in a highly surge-like manner as a result of wastewater arriving at the heat transfer apparatus directly from service. Therefore, in heat exchanger equipment intended for recovering the heat energy of wastewater, it has been necessary to accompany the heat exchangers with technically complicated flowing or pumping arrangements used in an effort to equalize, obstruct or otherwise intermit the flow of wastewater on the heat exchanger's primary side, especially in winter. This partial or complete obstruction of wastewater passage results in even more complicated flow arrangement for the heat transfer apparatus.

Typically, in such wastewater heat energy recovery systems, wherein the heat energy of wastewater is recovered into a heat transfer fluid with a shell and tube heat exchanger of the above-described type, it has necessarily been further necessary to limit to the recovery of heat energy contained in just one type of wastewater, i.e. predominantly in residential greywater, and, on the other hand, the recovered heat energy has been most commonly used only for the heating of domestic hot water.

At the moment there are no commercially available heat exchanger assemblies, wherein the shell and tube heat exchanger having a spiral type tube side/spiral pipe) could be used not only for ordinary residential wastewaters (greywater, urban runoff) but also for so-called blackwater and further also for dirty municipal wastewaters so as to recover the heat energy thereof in such a way that the heating or cooling energy of wastewater could also be conducted to an optional non-pressurized or pressurized heat transfer fluid, which is flowing on the shell side of such a shell and tube heat exchanger.

This is firstly due to the fact that the recovery of energy from dirty blackwater flowing inside the spiral pipe of a shell and tube heat exchanger may cause problems as a result of clogged heat exchanger tubes. If an effort is made to prevent a spiral pipe clogging by replacing the spiral pipe on the tube side of a shell and tube heat exchanger with a straight pipe, this will result, on the other hand, in a significantly deteriorated heat transfer coefficient for the shell and tube heat exchanger as the heat transfer area diminishes and dwell time in the heat exchanger becomes shorter.

Accordingly, it is an objective of the invention to provide a method and an adjustment system for the recovery of wastewater heat energy in a container, which comprises a spiral pipe heat exchanger, wherein the wastewater flow coming into the spiral pipe would not have to be intermitted but it could come directly from service into the primary side of a heat exchanger.

It is a further objective of the invention to provide a method and an adjustment method which would enable various dirty municipal wastewaters and residential wastewaters to be conveyed on a shell and tube heat exchanger's tube side, made up of a spiral pipe, for recovering the wastewater heat energy into a heat transfer fluid enveloping the spiral pipe on the shell and tube heat exchanger's shell side.

Thus, it was an objective in the present invention to provide an effective method for the recovery of wastewater heat energy, wherein the heating or cooling energy of wastewater flowing continuously inside a spiral pipe present in a container is enabled to be effectively transferred into a possibly pressurized heat transfer fluid flowing on the shell side of a heat exchanger, said heat transfer fluid being selectable from among various heat transfer fluids capable of being heated or cooled, such as a primary side geothermal heat transfer fluid and a ventilation heat transfer fluid.

It was a further objective of the invention to keep the tube side and shell side of a shell and tube heat exchanger according to the invention structurally as simple as possible. A particular objective was to maintain such a structure of the heat exchanger that it would not include electrical flowing and pumping arrangements used for regulating flow specifically on the heat exchanger's tube side.

In this disclosure, the shell and tube heat exchanger's shell side (i.e. secondary side) refers to a first heat transfer space, which is defined between the container shell and the outer shell of a spiral pipe, and in which the heat transfer fluid is flowing. The energy of wastewater flowing in a spiral pipe present on the shell and tube heat exchanger's tube side or primary side is recovered into the heat transfer fluid flowing on the shell side.

The recovery of wastewater heat energy refers in this context to recovering both the heating energy and the cooling energy of wastewater, depending on whether the wastewater flowing on the heat exchanger's tube side is at a temperature higher or lower than a heat transfer fluid of the shell side.

The wastewater refers in this disclosure to a disposable water-based liquid having been used for municipal or residential service. In reference to residential buildings, the wastewater consists of urban runoff, greywater or blackwater.

It is with a method defined in claim 1 for controlling the recovery of heat energy from wastewater flowing in a spiral pipe present inside a container, and with an adjustment system presented in claim 14 for controlling the recovery of heat energy from wastewater flowing in a spiral pipe present inside a container, that the foregoing objectives are attained.

More specifically, the invention relates to a method for controlling the recovery of heat energy from wastewater flowing in a spiral pipe present inside a container. The container comprises a shell defining said container outwards and a continuous spiral pipe for conveying wastewater through the container in vertical direction. The spiral pipe is in communication with an extra-container wastewater ingress pipe by way of an inlet connection associated with the container shell and with an extra-container wastewater egress pipe by way of an outlet connection associated with the container shell, and a first heat transfer space encircling a shell of the spiral pipe and being confined by an outer shell of said spiral pipe and the shell of the container, and said first heat transfer space being in communication with a heat transfer fluid ingress conduit by way of at least one heat transfer fluid inlet connection associated with the shell of the container, and with a heat transfer fluid egress conduit by way of at least one heat transfer fluid outlet connection associated with the shell of the container. Inside the spiral pipe is left a second heat transfer space which is confined by an outer shell of said spiral pipe, whereby the method comprises controlling the recovery of heat energy from wastewater flowing in the spiral pipe into a heat transfer fluid flowing in the first heat transfer space encircling the spiral pipe with a temperature difference between the wastewater and the heat transfer fluid flowing in the heat transfer space. The method comprises conducting a heat transfer fluid arriving at a bypass connection included in the heat transfer fluid ingress pipe on the one hand into the heat transfer fluid ingress pipe and further into a volume flow arriving in the first heat transfer space of the container, as well as on the other hand into a volume flow of the heat transfer fluid bypassing the container, whereby a ratio between the arriving volume flow of the heat transfer fluid and the volume flow bypassing the container is adjusted by:

A) adjusting the heat transfer coefficient through a spiral type wall of the wastewater pipe by means of form factors of the spiral pipe's helices, and

B) measuring the heat transfer fluid for its temperature in the container's first heat transfer space, and possibly by measuring also said heat transfer fluid arriving in the first heat transfer space for the rate of its volume flow, and/or by measuring the wastewater arriving inside the spiral pipe for its temperature, and possibly by measuring also the wastewater arriving inside said spiral pipe for the rate of its volume flow, as well as

C) controlling with an adjustment unit, on the basis of points A and B, the heat transfer fluid arriving in the first heat transfer space for said rate of its volume flow in the ingress conduit in such a way that the temperature of a heat transfer fluid arriving in the first heat transfer space of the container remains all the time either lower than the temperature of the wastewater flowing in the spiral pipe or higher than the temperature of the wastewater flowing in the spiral pipe.

The concepts the temperature of a heat transfer fluid remains all the time either lower than the temperature of the wastewater (J) flowing in the spiral pipe or all the time higher than the temperature of the wastewater (J) flowing in the spiral pipe are used in reference to the fact that the average temperature of the heat transfer fluid over the measuring period is maintained on average higher or, respectively, on average lower than the temperature of the wastewater (J) flowing in the spiral pipe.

An adjustment system of the invention, on the other hand, comprises controlling the recovery of heat energy from wastewater flowing in a spiral pipe present inside a container. The container comprises a shell defining said container outwards, a continuous spiral pipe for conveying wastewater through the container in vertical direction, said spiral pipe being in communication with an extra-container wastewater ingress pipe by way of an inlet connection associated with the container shell, and with an extra-container wastewater egress pipe by way of an outlet connection associated with the container shell. The container further comprises a first heat transfer space encircling a shell of the spiral pipe and being confined by an outer shell of said spiral pipe and by the shell of the container, and said first heat transfer space being in communication with a heat transfer fluid ingress conduit by way of at least one heat transfer fluid inlet connection associated with the shell of the container, and with a heat transfer fluid egress conduit by way of at least one heat transfer fluid outlet connection associated with the shell of the container, . as well as a second heat transfer space left inside the spiral pipe and confined by an outer shell of said spiral pipe. The adjustment system comprises temperature measuring means as well as means for controlling the recovery of energy from wastewater flowing in the spiral pipe into a heat transfer fluid present in a heat transfer space surrounding said spiral pipe, whereby said control of the heat energy recovery is carried out on the basis of a temperature difference between the wastewater flowing in the spiral pipe and the heat transfer fluid arriving in the heat transfer space. The adjustment system further comprises
temperature measuring means, comprising elements for measuring the temperature of a heat transfer fluid flowing inside the container by means of temperature measuring devices preferably present in a lower part, middle part and upper part of the container's shell, as well as possibly also elements for measuring the temperature of wastewater flowing inside the spiral pipe by means of temperature measuring devices located at the spiral pipe's inlet and outlet connections,
a heat transfer fluid ingress pipe by way of which the first heat transfer space of the container is capable of being supplied with a volume flow of the heat transfer fluid, as well as, on the other hand, a bypass conduit by way of which a volume flow of the heat transfer fluid is capable of being conducted past the container, and
control means used for adjusting a ratio between the volume flow of the heat transfer fluid arriving in the first heat transfer space and the volume flow bypassing the container on the basis of temperature measurement data obtained from the temperature measuring means as well as on the basis of form factors of the spiral pipe's helices in such a way that the temperature of the heat transfer fluid conducted into the heat transfer fluid ingress pipe remains all the time lower or higher than the temperature of wastewater flowing in the spiral pipe, and said form factors being selected from among those including the static form factors of helices.

The concepts the temperature of a heat transfer fluid remains all the time either lower than the temperature of the wastewater (J) flowing in the spiral pipe or all the time higher than the temperature of the wastewater (J) flowing in the spiral pipe are again used in reference to the fact that the average temperature of the heat transfer fluid over the measuring period is maintained on average higher or, respectively, on average lower than the temperature of the wastewater (J) flowing in the spiral pipe.

The present invention is based on a capability of having a primary side made up of the spiral pipe of a shell and tube heat exchanger supplied continuously with wastewater from a service site while the flow a heat transfer fluid being conducted onto the container's shell side is regulated by a bypass connection.

On the other hand, the invention is based on adjusting operation of the bypass connection with static form factors of the spiral pipe's helices, as well as by measuring continuously temperature of the heat transfer fluid inside the container.

When static form factors are taken into consideration in the operation of a bypass connection, there will be achieved the significant benefit of being first of all able to use wastewater supplied from a desired source by modifying the spiral's operation and heat transfer coefficient as desired. Thereafter, it will be possible to take into consideration the effect of wastewater quality on the spiral pipe's static form factors and further on the heat transfer coefficient from wastewater to a heat transfer fluid enveloping the spiral pipe. It is on the basis of these factors that the bypass connection is adjusted.

In one preferred embodiment of the invention, the heat transfer coefficient is adjusted by changing the helix angle of a spiral pipe's helices, said helix angle being 0-10 degrees per spiral.

Here, the helix angle of a spiral refers to an angle of incidence of the center line of a single spiral of the wastewater pipe, i.e. an upward directed helix of the spiral pipe, with respect to a horizontal plane extending crosswise to a center line of the spiral pipe.

In another preferred embodiment of the invention, the heat transfer coefficient is adjusted by changing the ratio of a spiral pipe's heat transfer area to the height of a vertical space defined by the spiral pipe's helices.

The height of a vertical space defined by the helices refers to a maximum distance between the highest and lowest helices of a spiral pipe. The spiral pipe's heat transfer area, on the other hand, refers to an aggregate surface area of the spiral pipe's helices.

In yet another preferred embodiment of the invention, the heat transfer coefficient is adjusted by means of the number of horizontal angles present in the spiral pipe's helices and by the magnitude of said angles.

The horizontal angles of helices or threads refer to flexures or angles, which are included in helices and which, as seen from a center line of the spiral pipe, are directed inward or outward from a shell of the spiral pipe. At an angle included in the helix, the radius of a helix, measured from the pipe's longitudinal center line, differs either from the average radius of the same helix and/or from the average radius of the spiral pipe's helices when measured from the lengthwise, i.e. vertical, center line of the spiral pipe.

In another preferred embodiment of the invention, the heat transfer coefficient is adjusted by means of a radius of the spiral pipe's helices as measured from the vertical center line of the spiral pipe.

In another preferred embodiment of the invention, the temperature of a heat transfer fluid coming into the first heat transfer space is measured, and, possibly, the temperature of a heat transfer fluid going out of said heat transfer space is also measured, by means of temperature measuring elements included in a lower part, middle part and upper part of the container's shell.

Preferably, the method further includes a step of conveying wastewater gravitationally along the internal surface of a spiral pipe of continuous configuration, whereby the flow rate of a liquid inside the spiral pipe depends on the spiral's static form factors.

In one preferred embodiment of the invention, the flow of wastewater inside the spiral pipe is adapted to occur continuously by designing the spiral pipe's internal surface and the spiral pipe's lengthwise opening to be continuous, whereby the flow rate inside the pipe depends on the form factors of the spiral pipe's helices.

The invention and benefits attainable therewith will now be described in even more detail with reference to the accompanying figures.

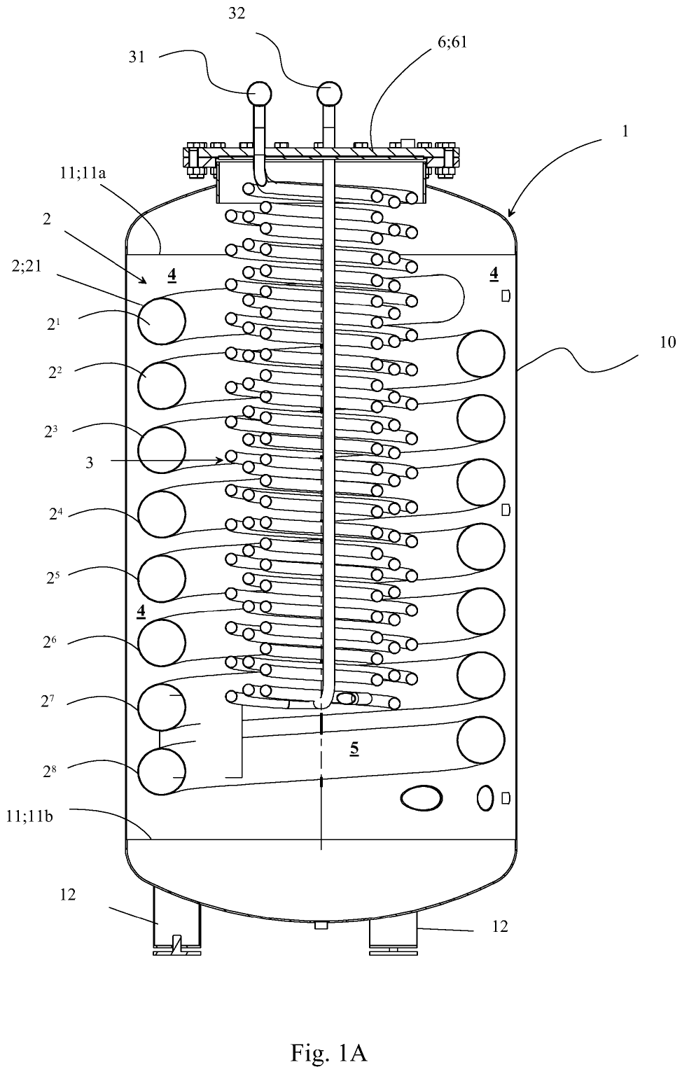

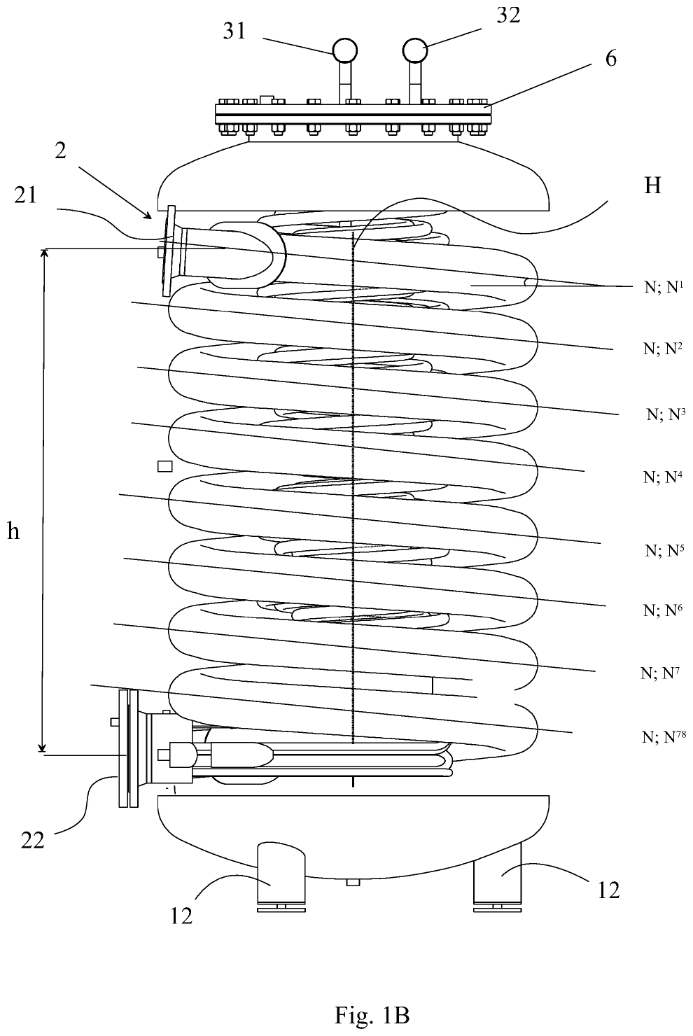

FIG. 1A shows a vertical section view of a container suitable for recovering the heat energy of wastewaters.

FIG. 1B shows the container of FIG. 1A without an outer shell.

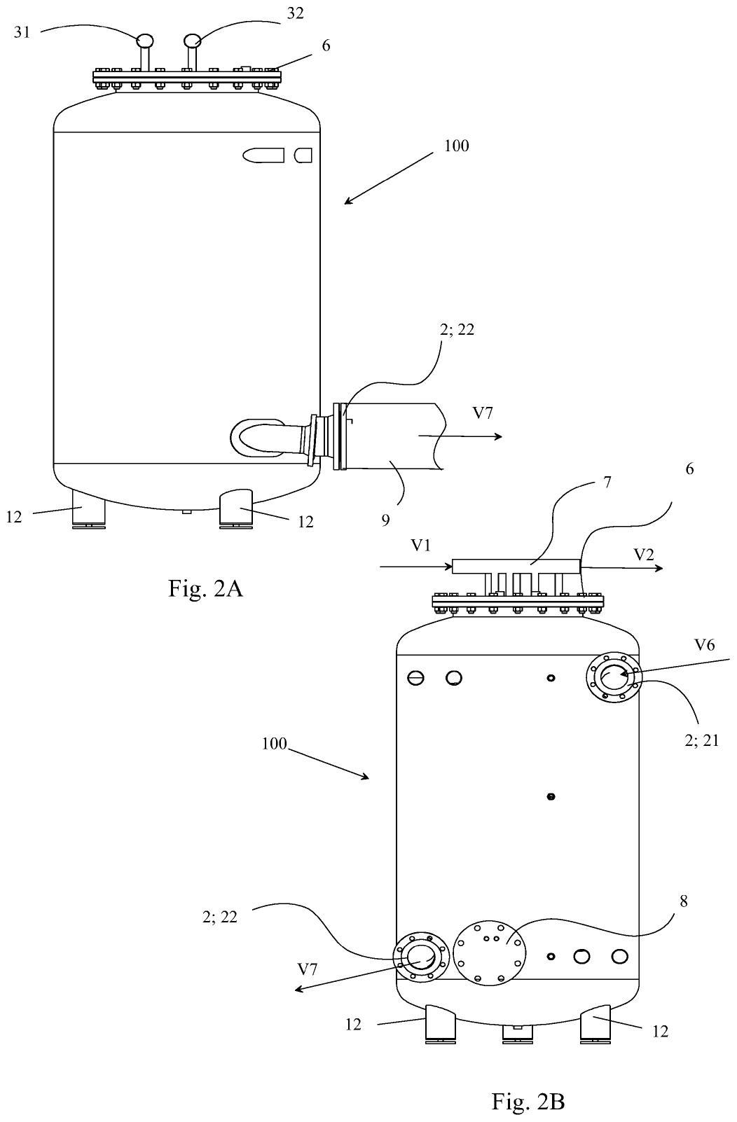

FIGS. 2A and 2B show from slightly different viewing angles the container of FIG. 1 as seen from outside.

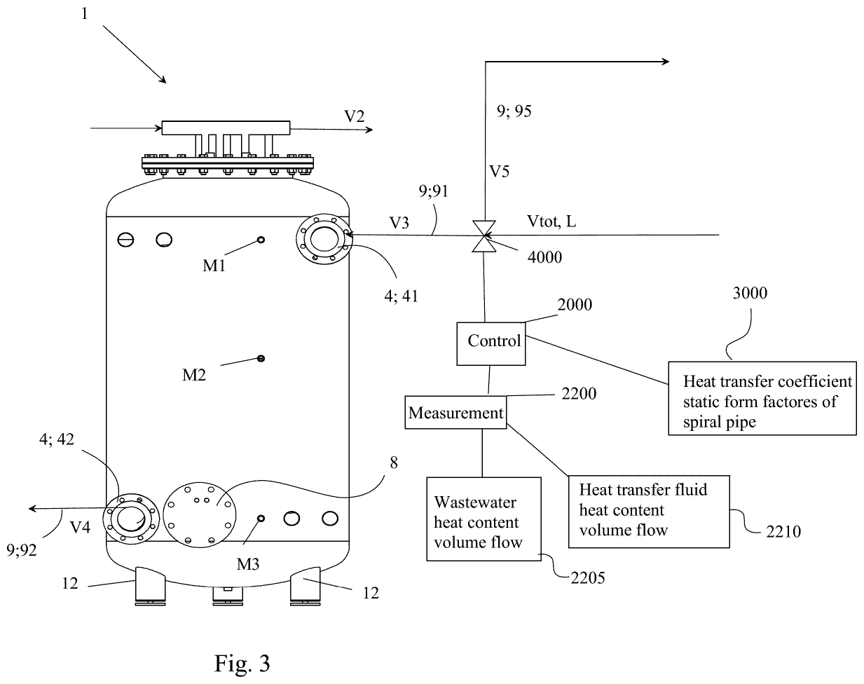

FIG. 3 shows the container in a view from outside and provided with a schematically presented bypass connection.

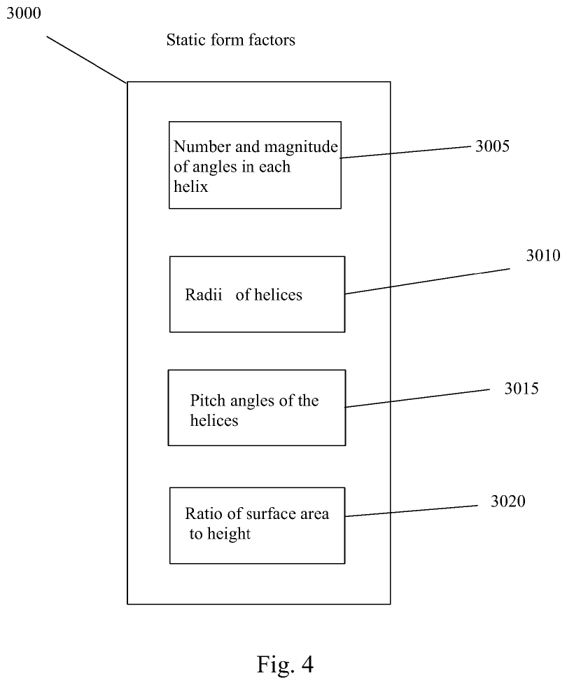

FIG. 4 shows form factors for helices.

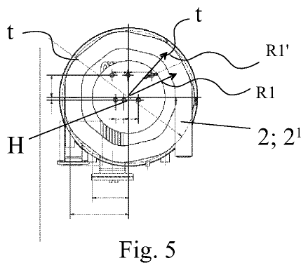

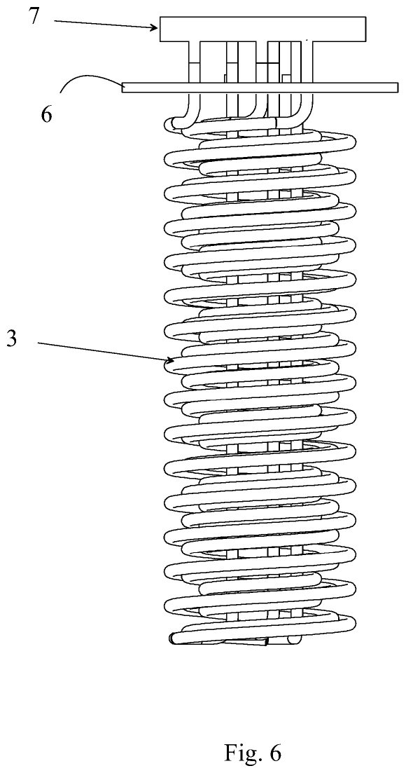

FIG. 5 shows a spiral pipe in a cross-section view directly from above.

FIG. 1A shows in a lengthwise section view a container according to a first embodiment of the invention, which functions as a shell and tube heat exchanger for example for the recovery of heat energy from the grey or black waters of an apartment building. FIG. 1B depicts the container of FIG. 1A without a shell.

FIGS. 2A, 2B and 3 illustrate how wastewaters and heat transfer fluids are introduced into the container 1 or discharged from the container.

As seen from the lengthwise section view of a container 1 shown in FIGS. 1A and 1B, the container, which functions as a shell and tube heat exchanger, has an outer shell 10 as well as a continuous spiral pipe 2 for conveying wastewater through the container 1 in vertical direction. Generally, wastewater J travels gravitationally in a top-down direction through the container 1. The container is provided with a stand 12.

The spiral pipe 2 has its shell, i.e. the spiral pipe's outer wall, directly encircled by a first heat transfer space 4, which at the same time makes up a shell portion for the shell and tube heat exchanger. The first heat transfer space 4 is defined by an outer wall of the spiral pipe 2 and by an outer shell 10 (double shell) of the container 1. The container 1 is also marked with horizontal floors (connection joints) 11; 11a and 11; 11b at upper and lower parts of the container's shell 10, whereby the container's upper and lower parts are connected to a vertical portion of the shell 10.

This first heat transfer space 4 is in communication with an ingress conduit 9; 91 for a heat transfer fluid L by way of at least one heat transfer fluid inlet connection 4; 41 associated with the shell 10 of the container 1, and with a heat transfer fluid egress conduit 9; 92, especially a heat transfer fluid egress pipe, by way of at least one heat transfer fluid outlet connection 4; 42 associated with the shell 10 of the container 1. Inside the spiral pipe 2 is left a second heat transfer space 5, which is thereby located in a vertical space h confined by the spiral pipe's 2 helices 2; 2¹. . . 2⁸. At least a portion of the container 1 is provided as a pressure vessel.

FIG. 1B illustrates the spiral pipe's helices in slightly more detail. Each helix 2¹. . . 2⁸ can have its pitch angle N; N¹. . . N⁸ selected from within the range of 0-10 degrees. The pitch angle of a helix has a direct effect on the flow rate of wastewater J traveling inside said helix 2¹. . . 2⁸ and thereby on the turbulence in the flow of wastewater J and further on the heat transfer coefficient from wastewater to a heat transfer fluid L enveloping the spiral pipe 2.

From FIGS. 2A and 2B can be seen in more detail, among others, the construction of the container's 1 shell 10 and a manifold 7 connected to an inspection hatch 6 (a manhole) at an upper part of the container. The upper part of the container's 1 shell 10, visible in FIGS. 2 and 3, is provided with an openable inspection hatch 6. On top of the inspection hatch 6 is integrated or fixedly secured a manifold 7. The manifold 7 includes a first valve system or the like, by which can be opened an inlet path for wastewater to the manifold 7 from two different directions from outside the container. The manifold 7 is further provided with means, such as a second valve system, for opening and closing a fluid connection from said manifold 7 to a spiral type shell and tube heat exchanger 3 located in a second heat transfer space 5 of the container 1. The shell and tube heat exchanger has its inlet and outlet ends 31,32 connected to said manifold 7. This way, the manifold 7, the shell and tube heat exchanger 3 and the inspection hatch constitute a single entity removable from the container all at once.

It can be seen from FIG. 3 how a flow V1 of heat transfer fluid L, such as water, arrives at the manifold 7 and further inside the container. The heat transfer fluid L passes by way of a spiral type shell and tube heat exchanger present inside the spiral pipe 2 and delivers its thermal energy at the same time into the heat transfer space 5. After this, a cooled or heated flow V2 of water discharges from the heat manifold 7 and out of the container 1.

The flow of wastewater J, on the other hand, arrives from an upper part of the container by way of an inlet connection 2; 21 inside the container 1 (cf. FIG. 1). Inside the container, it proceeds along the spiral pipe 2 gravitationally downwards and delivers thermal energy at the same time to the heat transfer fluid L present in the shell portion 4. Thereafter, the wastewater discharges from the container by way of an outlet connection 2; 22.

The material thickness for a wall of the spiral pipe 2 visible in FIG. 1 with respect to an average cross-sectional diameter of the spiral pipe is selected in such a way that the spiral pipe 2 has a maximum pressure resistance level of 10-16 bar. The material thickness for the container's 1 double shell 10 with respect to the container's internal diameter is in turn selected in such a way that the container has a maximum pressure resistance level of 6-10 bar. Hence, the spiral pipe in the container's 1 tube portion has a maximum pressure resistance level which is slightly higher than the highest possible pressure resistance level of the container's shell portion.

The material thickness for a wall of the spiral coil 3 visible in FIG. 1 with respect to an average cross-sectional diameter of the spiral pipe is selected, on the other hand, in such a way that the spiral coil 3 has a maximum pressure resistance level of 10-16 bar.

Regarding its material, the spiral pipe 2 intended for wastewater and visible in FIG. 1 is made of acid-proof steel and has its internal surface treated, preferably by electrolytic polishing, to a surface roughness below Ra=120. In addition, the treatment for an internal surface of the spiral pipe 2 is selected in such a way that, by means of said treatment, the internal surface of the spiral pipe 2 has its average chromium content adapted to be higher than the average chromium content of other wall parts of the spiral pipe 2. Electrolytic polishing levels electrochemically the microscopically small irregularities on an internal wall surface of the spiral pipe 2, whereby the dirt does not adhere to the spiral pipe's internal surface as the heat energy is recovered for example from blackwater. On the other hand, increasing the chromium content on an internal surface of the spiral pipe 2 improves the corrosion resistance of the internal surface.

It is in FIGS. 3 and 4 that an adjustment system of the invention is illustrated.

The adjustment system comprises temperature measuring means, as well as means for controlling the recovery of energy from wastewater J flowing in a spiral pipe 2 into a heat transfer fluid L present in a heat transfer space 4 surrounding the spiral pipe 2. The control of heat energy recovery is conducted on the basis of a temperature difference between the wastewater J flowing in the spiral pipe 2 and the heat transfer fluid L flowing in the heat transfer space 4.

In the embodiment of the invention visible in FIG. 3, the temperature of heat transfer fluid L flowing in a heat transfer space 4 (shell space) inside the container 1 can be measured by means of measuring devices M3, M2 and M1 present respectively at a lower part, middle part and upper part of the container's shell. It is further possible to measure the temperature of wastewater J flowing inside the spiral pipe 2 by means of temperature measuring devices (not shown in the figures) located respectively at inlet and outlet connections 2; 21, 2; 22 of the spiral pipe.

The container 1 has its first heat transfer space 4 capable of being supplied with a volume flow V3 of heat transfer fluid L by means of a heat transfer fluid ingress conduit 9; 91, such as an ingress pipe. A portion V5 of the total flow Vtot of heat transfer fluid L arriving at a valve 4000 can be directed into a heat transfer fluid bypass conduit 9; 95, such as a bypass pipe, by way of which a specific portion V5 (bypass flow) of the total volume flow Vtot of heat transfer fluid L can be further conducted past the container. A control 2000 of the adjustment system is performed with control elements by means of which is conducted an adjustment of a ratio V3/V5 between the volume flow V3 of heat transfer fluid arriving in the container and the volume flow V5 bypassing the container. The control 2000 is carried out on the basis of a temperature and flow measurement 2200. Therefore, the wastewater J is measured for its heat content and possibly also for its volume flow at 2210. Another consideration regarding the control 2200 relates to static form factors 3000 of the spiral pipe's 2 helices. The form factors include pitch angles N; N¹-N⁸ (3015) of the helices 2¹. . . 2⁸, which are selected from within the range of 0-10 degrees for each helix 2¹. . . 2⁸, the ratio of the spiral pipe's 2 heat transfer area to a height h of the vertical space defined by a helix 2¹. . . 2⁸ (3020), the number of horizontal angles tin the spiral pipe's helices 2¹. . . 2⁸ and the magnitude of angles t (3005), as well as the radius of each of the spiral pipe's helices 2¹. . . 2⁸ from a vertical center line H of the spiral pipe (3010). The control relates to a volume flow (V3) of the heat transfer fluid (L) and arriving on the one hand in the ingress conduit (9; 91) for heat transfer fluid (L) and further in the first transfer space (4) of the container (1).

It is an objective of the control 2000 to maintain the heat transfer fluid L, which has been conducted into the ingress conduit 9; 91 of the heat transfer fluid, and especially into the heat transfer fluid ingress pipe 9; 91 delivering the heat transfer fluid L into the first heat transfer space 4 of the container 1, all the time at a temperature lower than that of the wastewater J flowing in the spiral pipe 2 or higher than that of the wastewater J flowing in the spiral pipe.

It is the section view of FIG. 5 which illustrates horizontal angles for helices of the spiral pipe 2. In a helix 2¹ of the spiral pipe 2, visible in the figures, i.e. in a thread of the spiral pipe, the helix has its radius R1 outside bends t. The radius is measured as a distance from a vertical center line H of the spiral pipe to a lengthwise center line of the helix. On the other hand, at each horizontal angle, i.e. at a bend t of the helix, the distance or radius of curvature is R1′, again measured as a distance from the spiral pipe's 2 vertical center line H to the helix's center line. The angles t of helices have an impact on the traveling speed and turbulence of the wastewater J in the helices 2¹. . . 2⁸ and thereby on the transfer of heat from a liquid flowing inside the spiral pipe 2 into the heat transfer fluid L enveloping the spiral 2.

It is obvious for a skilled artisan that there are a multitude of other possible implementations for the invention within the scope of an inventive concept defined in the claims.

### LIST OF REFERENCE NUMERALS

1 Container
2 Wastewater pipe, spiral pipe
2¹-2⁸ helices
21, 22 inlet and outlet connections (for spiral pipe)
3 Shell and tube heat exchanger
31,32 inlet and outlet connections (for shell and tube heat exchanger)
4 First heat transfer space
4; 41 heat transfer fluid inlet connection
4; 42 heat transfer fluid outlet connection
5 Second heat transfer space
6 Inspection hatch
61 top inspection hatch (cover)

7 Manifold
8 Flange connection
9; 91 Heat transfer fluid ingress conduit, ingress pipe
9; 92 Heat transfer fluid egress conduit
9;95 Heat transfer fluid bypass conduit
10 Container's shell
Floor (joint)
11a upper floor
11b lower floor
12 (container's) stand
2000 Control
3000 Heat transfer coefficient, spiral pipe's static factors
3005 angles
3010 radii of the helices
3015 pitch angles of the helices
3020 surface area, ratio to height
2200 Measurement
2205 wastewater
2210 heat transfer fluid
4000 Valve
h Height of the vertical space
H Vertical center line of the spiral pipe
L Heat transfer fluid
J Wastewater
M1, M2, M3 Measuring devices (temperature)
N Pitch angle
R1 Radius of the helix
t Angle of the helix
V3 Heat transfer fluid, incoming volume flow
V4 Heat transfer fluid, outgoing volume flow
V5 Heat transfer fluid bypass flow, volume flow
V6 Wastewater, incoming volume flow
V7 Wastewater, outgoing volume flow
Vtot Heat transfer fluid, total flow

1. A method for controlling the recovery of heat energy from wastewater flowing in a spiral pipe present inside a container, said container comprising a shell defining the container outwards, a continuous spiral pipe for conveying wastewater through the container in vertical direction, said spiral pipe being in communication with an extra-container wastewater ingress pipe by way of an inlet connection associated with the container shell and with an extra-container wastewater egress pipe by way of an outlet connection associated with the container shell, a first heat transfer space encircling a shell of the spiral pipe and being confined by an outer shell of said spiral piped and by the shell of the container, and said first heat transfer space being in communication with a heat transfer fluid ingress conduit by way of at least one heat transfer fluid inlet connection associated with the shell of the container, and with a heat transfer fluid egress conduit by way of at least one heat transfer fluid outlet connection associated with the shell of the container, as well as a second heat transfer space left Inside the spiral pipe and confined by an outer shell of said spiral pipe, whereby the method comprises controlling the recovery of heat energy from wastewater flowing in the spiral pipe into a heat transfer fluid flowing in the first heat transfer space encircling the spiral pipe with a temperature difference between the wastewater and the heat transfer fluid flowing in the heat transfer space, wherein the method comprises the following steps of:
conducting a volume flow of heat transfer fluid arriving at a bypass connection included in the ingress conduit of the heat transfer fluid on the one hand into the ingress conduit of the heat transfer fluid and further into a volume flow of the heat transfer fluid arriving in the first heat transfer space of the container as well as on the other hand into a volume flow of the heat transfer fluid bypassing the container, whereby a ratio, between the volume flow of the heat transfer fluid arriving in the first heat transfer space. of the container and the volume flow of the heat transfer fluid bypassing the container is adjusted by:
A) adjusting the heat transfer coefficient through a spiral type wall of the wastewater pipe by means of form factors of the spiral pipe's helices, the selection of said form factors depending on wastewater quality, and
B) measuring the heat transfer fluid for its temperature in the container's first heat transfer space, and possibly by measuring also said heat transfer fluid arriving in the first heat transfer space of the container for the rate of its volume flow, and/or by measuring the wastewater arriving inside the spiral pipe for its temperature, and possibly by measuring also the wastewater arriving inside said spiral pipe for the rate of its volume flow, as well as
C) controlling with an adjustment unit, on the basis of points A and B, the heat transfer fluid arriving in the first heat transfer space for said rate of its volume flow in the ingress conduit in such a way that the temperature of a heat transfer fluid arriving in the first heat transfer space of the container remains all the time either lower than the temperature of the wastewater flowing in the spiral pipe or higher than the temperature of the wastewater flowing in the spiral pipe.

2. The method according to claim 1, wherein the heat transfer fluid arriving in the first heat transfer space is at a temperature which is lower than the temperature of liquid wastewater arriving in the container, and the heat transfer fluid is selected from a group which comprises collection liquid of a heat pump's primary side, ventilation condensation liquid.

3. The method according to claim 1, wherein the material thickness for the spiral pipe with respect to an average cross-sectional diameter of the spiral pipe is selected on the one hand in such a way that the spiral pipe has a first pressure resistance level, and the material thickness for the shell. of the container with respect to an internal diameter of the container is selected on the other hand in such a way that the container has a second pressure resistance level, whereby the spiral pipe's pressure resistance level is different from the container's pressure resistance level.

4. The method according to claim 1, wherein the heat transfer coefficient is adjusted by selecting a pitch angle for helices of the spiral pipe, said pitch angle being 0-10 degrees in each helix.

5. The method according to claim 1, wherein the heat transfer coefficient is adjusted by changing the ratio of a heat transfer area of the spiral pipe to a height of the vertical space defined by the spiral pipe's helices.

6. The method according to claim 1, wherein the heat transfer coefficient is adjusted by the number of horizontal angles included in the helices. of the spiral pipe and by the magnitude of angles.

7. The method according to claim 1, wherein the heat transfer coefficient is adjusted by changing a radius measured to a lengthwise center line of the spiral pipe's helices from a vertical center line of the spiral pipe.

8. The method according to claim 1, wherein the temperature of the heat transfer fluid arriving in the first heat transfer space, and possibly also the temperature of a heat transfer fluid discharging from said heat transfer space, is measured with measuring devices located at a lower part, middle part and upper part of the container's shell.

9. The method according to claim 8, wherein in case the heat transfer fluid has a temperature T≤0 in the heat transfer space, measured at a lower part of the container's shell, the heat transfer fluid arriving in said heat transfer space has a volume flow of 0 m³/min.

10. The method according to claim 1, wherein the method further includes a step, wherein one or more shell and tube heat exchangers, which are arranged in a second heat transfer space confined inside the spiral pipe and in which circulates a separate second heat transfer fluid, are used for heating/cooling the heat transfer fluid present in the first heat transfer space enveloping the spiral pipe.

11. The method according to claim 1, wherein the method further includes a step, wherein heat exchangers, present at additional connections included in the container's shell and/or cover, are used for heating/cooling the heat transfer fluid present in the heat transfer space enveloping the spiral pipe.

12. The method according to claim 9, wherein the container's shell includes flange connections through which are inserted one or more heat exchangers, such as solar thermal collectors, which extend into a heat transfer fluid pre-sent in the container's first heat transfer space, and said heat exchangers being used for transferring energy into or out of the heat transfer fluid present in the heat transfer space enveloping the spiral pipe.

13. The method according to claim 1, wherein the method further includes a step, wherein it is along an internal surface of the spiral pipe of continuous configuration that wastewater is conveyed gravitationally, whereby the flow rate of liquid inside the spiral pipe depends on static form factors of the spiral pipe.

14. An adjustment system for controlling the recovery of heat energy from wastewater flowing in a spiral pipe present inside a container, said container comprising a shell defining the container outwards, a continuous spiral pipe for conveying wastewater through the container in vertical direction, said spiral pipe being in communication with an extra-container wastewater ingress pipe by way of an inlet connection associated with the container shell, and with an extra-container wastewater egress pipe by way of an outlet connection associated with the container shell, a first heat transfer space encircling a shell of the spiral pipe and being confined by an outer shell of said spiral pipe and by the shell of the container, and said first heat transfer space being in communication with a heat transfer fluid ingress conduit by way of at least one heat transfer fluid inlet connection associated with the shell of the container, and with a heat transfer fluid egress conduit by way of at least one heat transfer fluid outlet connection associated with the shell of the container, as well as a second heat transfer space left inside the spiral pipe and confined by an outer shell of said spiral pipe,
said adjustment system comprising temperature measuring means as well as means for controlling the recovery of energy from wastewater flowing in the spiral pipe into a heat transfer fluid present in the first heat transfer space surrounding said spiral pipe, whereby said control of the heat energy recovery is carried out on the basis of a temperature difference between the wastewater flowing in the spiral pipe and the heat transfer fluid arriving in the first heat transfer space, wherein the adjustment system further comprises
temperature measuring means, comprising elements for measuring the temperature of a heat transfer fluid flowing inside the container by means of temperature measuring devices preferably present in a lower part, middle part and upper part of the container's shell, as well as possibly also by means of temperature measuring devices included in the actual heat transfer fluid ingress pipe, and for measuring the temperature of wastewater flowing inside the spiral pipe by means of temperature measuring devices located at the spiral pipe's inlet and outlet connections,
a heat transfer fluid ingress pipe by way of which the first heat transfer space of the container is capable of being supplied with a volume flow of the heat transfer fluid, as well as, on the other hand, a bypass conduit by way of which a volume flow of the heat transfer fluid is capable of being conducted past the container,
control means used for adjusting a ratio between the volume flow of the heat transfer fluid arriving in the first heat transfer space and the volume flow bypassing the container on the basis of temperature measurement data obtained from the temperature measuring means as well as on the basis of form factors of the spiral pipe's helices in such a way that the temperature of the heat transfer fluid conducted into the ingress pipe of the heat transfer fluid remains all the time lower or all the time higher than the temperature of wastewater flowing in the spiral pipe, and said form factors being selected from among those including the static form factors of helices.

15. The adjustment system according to claim 14, wherein, inside the spiral pipe, the flow of wastewater is adapted to occur continuously by designing an interior surface of the spiral pipe to be continuous and a lengthwise opening of the spiral pipe to be continuous, the flow rate inside the pipe depending on the form factors of the spiral pipe's helices.

16. The method according to claim 1, wherein the spiral pipe in terms of its material consists of acid-proof steel has its internal surface treated, preferably by electrolytic polishing, to a surface roughness below Ra=120, whereby the treatment conditions for the spiral pipe's internal surface are further selected in such a way that said treatment is capable of providing the spiral pipe's internal surface with an average chromium content which is higher than that in other wall parts of the spiral pipe.

17. The adjustment system according to claim 14, wherein the spiral pipe in terms of its material consists of acid-proof steel has its internal surface treated, preferably by electrolytic polishing, to a surface roughness below Ra=120, whereby the treatment conditions for the spiral pipe's internal surface are further selected in such a way that said treatment is capable of providing the spiral pipe's internal surface with an average chromium content which is higher than that in other wall parts of the spiral pipe.
